(19) United States
(12) Patent Application Publication
(10) Pub. No.: US 2011/0153829 A1
(43) Pub. Date: Jun. 23, 2011

(54) TRAFFIC ENGINEERING DATABASE CONTROL SYSTEM AND METHOD FOR GUARANTEEING ACCURACY OF TRAFFIC ENGINEERING DATABASE

(75) Inventors: TaeHyun Kwon, Andong (KR); Sun Me Kim, Daejeon (KR); Ho Young Song, Daejeon (KR)

(73) Assignee: Electronics and Telecommunications Research Institute, Daejeon (KR)

(21) Appl. No.: 12/972,851

(22) Filed: Dec. 20, 2010

(30) Foreign Application Priority Data
Dec. 21, 2009 (KR) 10-2009-0128147

(51) Int. Cl. G06F 15/16

(52) U.S. Cl. 709/226

(57) ABSTRACT

Provided is a traffic engineering database (TED) management method and system guaranteeing an accuracy of a TED. The TED management method includes reserving resource information in the TED based on a path transmitted from a path control function of a control plane or from a path control function of a management plane, and updating the TED based on a result of a path control process, the result indicating ‘success’ or ‘failure’ and being transmitted from the path control function of the control plane or from the path control function of the management plane.

### CROSS-REFERENCE TO RELATED APPLICATION

This application claims the benefit of Korean Patent Application No. 10-2009-0128147, filed on Dec. 21, 2009, in the Korean Intellectual Property Office, the disclosure of which is incorporated herein by reference.

### BACKGROUND

1. Field of the Invention

The present invention relates to a traffic engineering database (TED) management method and system guaranteeing a TED accuracy.

2. Description of the Related Art

A path computation element (PCE)-based path controlling method or a PCE-based path connection method may be classified into a provisioned connection (PC) scheme using a path control management system or a network control management system of a management plane, a soft permanent connection (SPC) scheme using a path control management system of a management plane and a control plane, and a switched connection (SC) scheme using only a control plane. The PC scheme may also be called a permanent connection scheme. The control plane may include a path computation client function, a routing processing engine function, and the like. The path computation client function requests the PCE to compute a path in response to a request of a signal processing engine, and receives a response to transmit a result of the computation to the signal processing engine.

Although the PC scheme may generally be used in a network excluding the control plane or in a network composed of network nodes, the PC scheme may also be used in a network including the control plane or in a network composed of network nodes. The SPC scheme and the SC scheme may be used in a network including a control plane or in a network composed of network nodes. Specifically, the SPC scheme and the SC scheme may use the path control function of the control plane. The path control function of the control plane may include the signal processing engine and a path computation client (PCC).

FIG. 1 illustrates a traffic engineering database (TED) updating method during a path setting process based on a conventional PCE based SPC scheme and a TED updating method during a path setting process based on a conventional PCE based SC scheme.

According to the path setting process based on the SPC scheme, a path control function of an ingress node may receive a path setting request command from a management plane. According to the path setting process based on the SC scheme, the path control function of the ingress node may receive the path setting request command from a User to Network Interface (UNI) or a Network to Network Interface (NNI). The received path setting request command may include information required for setting the path, the information including information associated with the ingress node, information associated with an egress node, information associated with bandwidth, path computation condition, and the like.

A signal processing engine of an ingress node of control plane that receives the path setting request command may request the PCE to compute a path using the PCC in operation 101. In this case, the PCC may transmit information included in the path setting request command using a path computation element protocol (PCEP), the information used for computing the path to the PCE. The PCE computes an optimal path based on the TED in response to the request in operation 102. Specifically, the PCE may use resource information and network topology information included in the TED, for example, a network topology, link state information associated with a link, a total link bandwidth, a reserved bandwidth, a reservable bandwidth, a link color, a TE metric, and the like.

The TED management system may maintain and manage a TED, and may collect or receive the network topology information and resource information from each network element (NE) to establish the TED. Specifically, the TED management system may periodically collect the network topology information and resource information from each NE through a management protocol, for example, a simple network management protocol (SNMP), command line interface (CLI), and transaction language 1 (TL1), in the management plane, or may receive resource information and network topology information changed in association with a routing processing engine of the control plane to establish the TED information from each NE through the management protocol in the management plane.

Therefore, the PCE may compute the optimal path that is from the ingress node, to a mid-node, and to the egress node, based on the TED information. The PCE may transmit, using the PCEP, the computed optimal path to the PCC of the ingress node that requests the computation in operation 103.

The PCC of the ingress node may transmit the received computed optimal path to the signal processing engine, and the signal processing engine may set a path in the network based on the computed optimal path in operations 104 and 104-1.

When the new path is successfully set, each NE for which a new path is set may report, to the TED management system, resource information and network topology information which may be changed in association with the newly set path in operation 105. Therefore, the TED management system may update the TED information based on the reported network topology information and the resource information in operation 106.

When the new path is successfully set or when a release of a path set in advance succeeds, the network topology and a state of the resources may be changed in the network, an amount of the change being the same as an amount of a bandwidth allocated to the newly set path or an amount of a bandwidth allocated to the released path. The change of the network topology and the state of the resources may be reflected in the TED through the management protocol of the management plane or routing processing engine of the control plane and may be used as data for a next path calculation.

When the change in the network topology and the state of resources are reflected in the TED every time the setting of the path or the releasing of the path is completed, an amount of controlling for the TED establishment or an amount of management protocol may increase, and thus, a load for managing the network may occur. To decrease the load, the change may be reflected in the TED based on a predetermined period or may be reflected when an amount of the change is greater than a predetermined threshold. In this case, however, a trade-off may exist, which may not guarantee an accuracy of the TED information during a predetermined time.

When the PCE computes a path having a low accuracy, for example, when the PCE calculates a redundancy path including the pre-computed resources or when the PCE calculates a path including unavailable resources, the computed path having the low accuracy may cause a failure of the path setting process when the path is set in the network, and thus, a new path calculation process and a new path setting process may additionally be needed.

### SUMMARY

An aspect of the present invention provides a traffic engineering database (TED) management method and system that may guarantee an accuracy of resource information and network topology information included in a TED.

According to an aspect of the present invention, there is provided a TED controlling method, and the method includes reserving resource information in the TED based on a path transmitted from a path control function of a control plane, and updating the TED based on a result of a path control process, the result indicating ‘success’ or ‘failure’ and being transmitted from the path control function of the control plane.

According to an aspect of the present invention, there is provided a TED managing method, and the method includes reserving resource information in the TED based on a path transmitted from a path control function of a management plane, receiving, from the path control function of the management plane, a result of a path control process with respect to the path, the result indicating ‘success’ or ‘failure’, and updating the TED based on the received result.

According to an aspect of the present invention, there is provided a TED managing system, and the system includes a reservation unit to receive, from a path control function of a control plane, a path that is calculated in advance, and to reserve resource information in the TED based on the received path, and an updating unit to update the TED based on a result of a path control process, the result indicating ‘success’ or ‘failure’ and being transmitted from the path control function of the control plane.

According to an aspect of the present invention, there is provided a TED managing system, and the system includes a reservation unit to receive, from a path control function of a management plane, a path that is calculated in advance, and to reserve resource information in the TED based on the received path, and an updating unit to update the TED based on a result of a path control process, the result indicating ‘success’ or ‘failure’ and being transmitted from the path control function of the control plane.

Additional aspects, features, and/or advantages of the invention will be set forth in part in the description which follows and, in part, will be apparent from the description, or may be learned by practice of the invention.

### Effect

According to embodiment, a path control function performs path controlling or path releasing and notifying a TED management system of information associated with a result of a path calculation process, a path setting process, and a path release process, and thus, may guarantee an accuracy of resource information and network topology information included in the TED in real time. In addition, a failure rate with respect to the path setting process may be minimized.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a traffic engineering database (TED) updating method during a path setting process based on a conventional path computation element (PCE) based soft permanent connection (SPC) scheme and a TED updating method during a path setting process based on a conventional PCE based switched connection (SC) scheme;

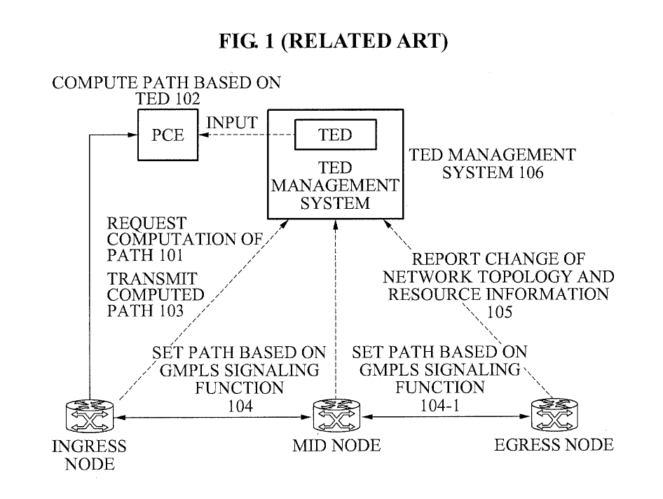

FIG. 2 is a diagram illustrating an example of guaranteeing an accuracy of a TED using a TED management system in a control plane according to an embodiment of the present invention;

FIG. 3 is a flowchart illustrating a TED updating method during a path control process including a path setting process and a path release process, according to an embodiment of the present invention; and

FIG. 4 is a diagram illustrating an example of guaranteeing an accuracy of a TED using a TED management system in a management plane according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

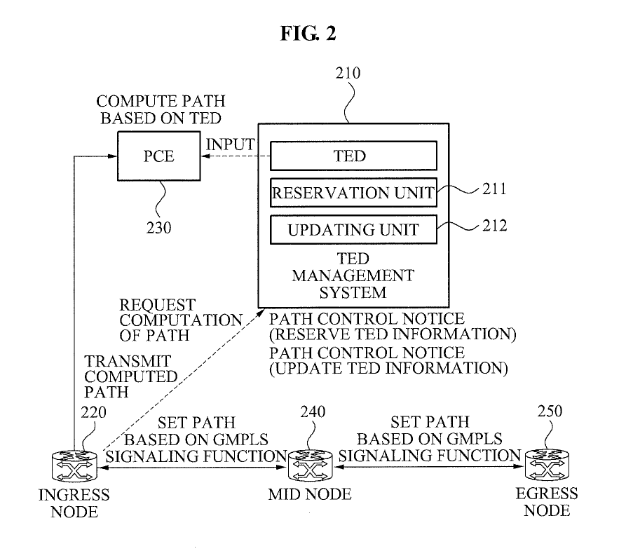

FIG. 2 illustrates an example of guaranteeing an accuracy of a traffic engineering database (TED) using a TED management system in a control plane according to an embodiment of the present invention

A path control function of an ingress node 220 may receive a path setting request command from a management plane when a path setting process is based on a soft permanent connection (SPC) scheme, and may receive a path setting request command from a User to Network Interface (UNI) or from a Network to Network Interface (NNI) when the path setting process is based on a switched connection (SC) scheme. The received path setting request command may include information required for setting a path, such as information associated with an ingress node, information associated with an egress node, information associated with a bandwidth, path computation conditions, and the like.

In this case, the path control function of the ingress node 220 may include a signal processing engine and a path computation client (PCC) that requests a path computation element (PCE) 230 to compute a path in response to a request of the signal processing engine and receives a result of the computation to transmit the result to the signal processing engine. The path control function may additionally include a path control notice function. The path control notice function may notify a TED management system 210 of information associated with controlling of the path, in response to the request of the signal processing engine.

The signal processing engine of the ingress node 220 that receives the path setting request command may request, using the PCC, the PCE 230 to compute an optimal path that is from the ingress node 220 to a mid-node 240, and to an egress node 250. In this case, the PCC may request the computation of the path by transmitting, to the PCE 230, a path computation request (PCReq) message including information used for the computation of the path, the information including information associated with an ingress node address, information associated with an egress node address, information associated with a bandwidth, information associated with a TE metric, and information associated with conditions.

The PCE 230 may compute, based on the TED, the optimal path that is from the ingress node 220 to the mid-node 240, and to the egress node 250, in response to the request. Specifically, the PCE 230 may compute, based on the TED, the path that satisfies an ingress node address, an egress node address, the bandwidth, the TE metric, and path computation conditions. For example, the PCE 230 may use network topology information and resource information included in the TED to compute the path. The TED may include the resource information and the network topology information used for computing the path, such as a network topology, link state information associated with a link, a total link bandwidth, a reserved bandwidth, a reservable bandwidth, a link color, a TE metric, and the like.

The PCE 230 may include the computed optimal path, namely an explicit route object (ERO) in a path computation reply (PCReply) message to transmit to the PCC of the ingress node 220. The PCC of the ingress node 220 that receives the PCReply may transmit a path computation result to the signal processing engine.

The signal processing engine of the ingress node 220 may transmit, to the TED management system 210, a bandwidth and the path computation result that is a path included in the ERO, using the path control notice function.

The reservation unit 211 of the TED management system 210 may reserve resource information associated with the corresponding path in the TED, based on the transmitted bandwidth and the path computation result. The TED management system 210 may generally maintain and manage the TED, and may collect or receive the network topology information and resource information from each network element (NE) to establish the TED, at an initial operation.

The signal processing engine of the ingress node 220 may transmit the bandwidth and the path computation result that is a path included in the ERO to the TED management system 210, and may simultaneously perform a path setting process based on the path computation result.

The signal processing engine of the ingress node 220 may transmit, to the TED management system 210, a result of the path setting process, the result indicating ‘success’ or ‘failure’, a bandwidth, route recorded object (RRO) information, a changed topology and resource information, using the path control notice function. For example, the path control notice function may transmit, to the TED management system 210, information associated with whether the path setting process succeeds or fails. The path control notice function may transmit ‘path release’ to the TED management system 210 when a path release process succeeds.

An updating unit 212 of the TED management system 210 may update the TED based on the result of the path setting process. For example, the updating unit 212 may update the reserved resource information with respect to the path in the TED as allocated resource information when the result indicates ‘success’. The updating unit 212 may release the reserved resource information with respect to the path in the TED when the result indicates ‘failure’. The updating unit 212 may release the resource information allocated with respect to the corresponding path in the TED when receiving ‘path release’.

For example, the path control notice function may transmit, to the TED management system 210, the result of the path setting process, the result indicating ‘success’ or ‘failure’, the bandwidth, the RRO information, the changed topology and resource information, using the signal processing engine. The RRO information may include an interface number and a node address included in the path setting process or a path release process and thus, the updating unit 212 may accurately update a portion of which a bandwidth is changed in the TED in the path setting process.

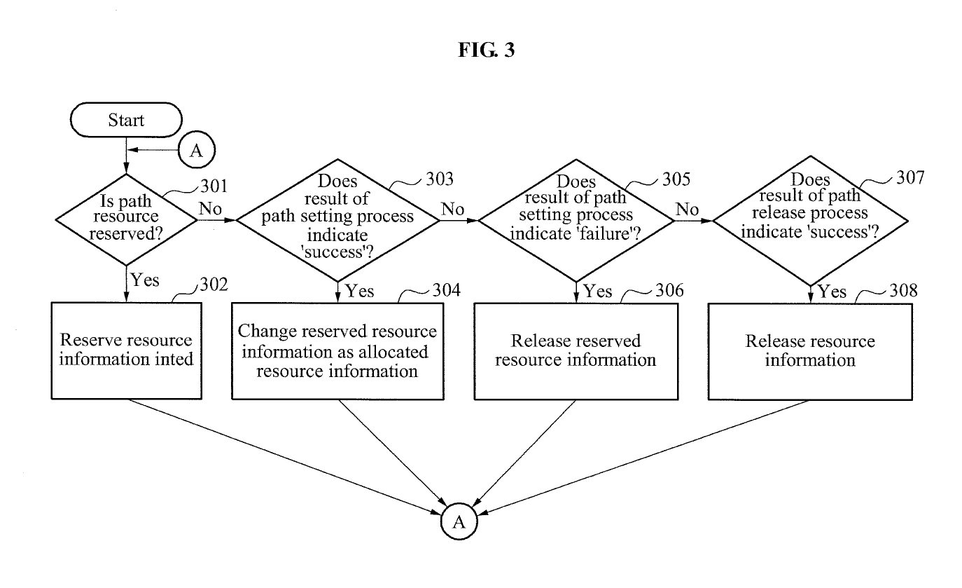

FIG. 3 illustrates a TED updating method during a path control process including a path setting process and a path release process, according to an embodiment of the present invention.

Referring to FIG. 3, when a path control notice function of the ingress node 220 notifies the TED management system 210 of a computed path, the TED management system 210 reserves resource information associated with the path in a TED in operations 301 and 302.

Subsequently, the TED management system 210 may receive, from the path control notice function of the ingress node 220, the result of the path setting process with respect to the computed path, a bandwidth, RRO information, changed topology and resource information, and may update the TED based on the received information.

When the result with respect to the path setting process indicates ‘success’ in operation 303, the TED management system 210 may change the resource information reserved in the TED as allocated resource information in operation 304.

When the result with respect to the path setting process indicates ‘failure’ in operation 305, the TED management system 210 may release the resource information reserved in the TED in operation 306.

When ‘path release’ is received with respect to a set path in operation 307, the TED management system 210 may release the resource information allocated in the TED in operation 308.

The TED management system 210 may receive a path control notice and information associated with path controlling from the path control notice function of a control plane, namely, a path control function of the control plane, and may receive information a path control notice and information associated with path controlling from a path control notice function of a management plane, namely, a path control function of the management plane.

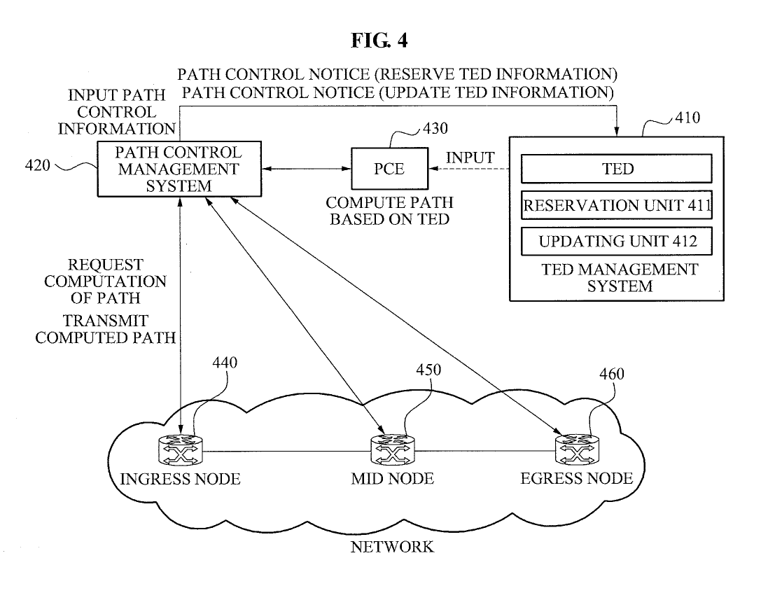

FIG. 4 illustrates an example of guaranteeing an accuracy of TED using a TED management system 410 in a management plane according to an embodiment of the present invention.

Referring to FIG. 4, a reservation unit 411 of the TED management system 410 may reserve resource information in a TED, based on a path transmitted from a path control function 420 of a management plane. Hereinafter, the path control function 420 is referred to as a path control management system. An updating unit 412 may receive a result of a path control process from the path control management system 420, and may update the TED based on the received result, the result indicating ‘success’ or ‘failure’ of the path control process.

For example, as illustrated in FIG. 2, the updating unit 412 may update the resource information reserved in the TED as allocated resource information when the result indicates ‘success’. When the result indicates ‘failure’, the updating unit 412 may release the resource information reserved in the TED.

The updating unit 412 may receive, from the path control management system 420, a result of a path release process with respect to a set path, and may release the resource information allocated to the TED when the result indicate ‘success’.

The path control management system 420 may receive a path setting request command from an operator. The received path setting request command may include information used for setting the path, such as information associated with the ingress node, information associated with an egress node, information associated with bandwidth, path computation conditions, and the like.

The path control management system 420 may request a PCE 430 to compute a path, may receive a path computation result, and may notify the TED management system 410 of the received path computation result. Specifically, the path control management system 420 may request, using a PCC, the PCE 430 to compute an optimal path that is from an ingress node 440 to a mid-node 450, and to an egress node 460. In this case, the PCC may transmit a path computation request message to the PCE 430 to request the computation of the path, the path computation request message including an ingress node address, an egress node address, a bandwidth, a TE metric, and information associated with conditions used for the computation of the path.

In response to the request, the PCE 430 may compute, based on the TED, the optimal path that is from the ingress node 440 to the mid-node 450, and to the egress node 460. Specifically, the PCE 430 may compute, based on the TED, the path satisfying the ingress node address, the egress node address, the bandwidth, the TE metric, and the information associated with conditions used for the computation of the path. For example, the PCE 430 may use resource information and network topology information included in the TED to compute the path. For example, the TED may include the resource information and the network topology information used for computing the path, such as link state information associated with a link with a network topology, a total link bandwidth, a reserved bandwidth, a reservable bandwidth, a link color, a TE metric, and the like.

The method according to the above-described embodiments of the present invention may be recorded in non-transitory computer readable media including program instructions to implement various operations embodied by a computer. The media may also include, alone or in combination with the program instructions, data files, data structures, and the like. Examples of non-transitory computer readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of controlling a traffic engineering database (TED), the method comprising:
reserving resource information in the TED based on a path transmitted from a path control function of a control plane; and
updating the TED based on a result of a path control process, the result indicating ‘success’ or ‘failure’ and being transmitted from the path control function of the control plane.

2. The method of claim 1, wherein the updating comprises:
receiving, from the path control function of the control plane, at least one among information associated with the result of the path control process, information associated with a bandwidth, and route recorded object (RRO) information; and
updating the TED using the at least one received information.

3. The method of claim 2, wherein the RRO information includes a node address and an interface number included in the transmitted path.

4. The method of claim 1, wherein the updating comprises:
updating the resource information reserved in the TED as allocated resource information when the result indicates ‘success’.

5. The method of claim 1, further comprising:
releasing resource information allocated in the TED when ‘path release notice’ is received from the path control function of the control plane.

6. The method of claim 1, wherein the updating comprises:
releasing the resource information reserved in the TED, when the result indicates ‘failure’.

7. A method of managing a TED, the method comprising:
reserving resource information in the TED based on a path transmitted from a path control function of a management plane;
receiving, from the path control function of the management plane, a result of a path control process with respect to the path, the result indicating ‘success’ or ‘failure’; and
updating the TED based on the received result.

8. The method of claim 7, wherein the updating comprises:
updating the resource information reserved in the TED as allocated resource information when the result indicates ‘success’; and
releasing the resource information reserved in the TED when the result indicates ‘failure’.

9. The method of claim 7, further comprising:
receiving, from the path control function of the management plane, a result of a path release process with respect to a set path, the result indicating ‘success’ or ‘failure’; and
releasing resource information allocated in the TED when the received result indicate ‘success’.

10. A system of managing a TED, the system comprising:
a reservation unit to receive, from a path control function of a control plane, a path that is calculated in advance, and to reserve resource information in the TED based on the received path; and
an updating unit to update the TED based on a result of a path control process, the result indicating ‘success’ or ‘failure’ and being transmitted from the path control function of the control plane.

11. The system of claim 10, wherein the updating unit updates resource information reserved in the TED as allocated resource information, when the result indicates ‘succeed’, and releases the resource information reserved in the TED when the result indicates ‘failure’.

12. The system of claim 11, wherein the updating unit releases the resource information allocated in the TED when ‘path release notice’ with respect to a set path is received from a path control function of the control plane.

13. The system of claim 10, wherein the updating unit receives at least one among information associated with the result of the path control process, information associated with a bandwidth, and RRO information; and updates the TED using the at least one received information.

14. A system of managing a TED, the system comprising:
a reservation unit to receive, from a path control function of a management plane, a path that is calculated in advance, and to reserve resource information in the TED based on the received path; and
an updating unit to update the TED based on a result of a path control process, the result indicating ‘success’ or ‘failure’ and being transmitted from the path control function of the control plane.

15. The system of claim 14, wherein the updating unit updates resource information reserved in the TED as allocated resource information, when the result indicates ‘succeed’, and releases the resource information reserved in the TED when the result indicates ‘failure’.

16. The system of claim 14, wherein the updating unit releases the resource information allocated in the TED when ‘path release notice’ with respect to a set path is received from a path control function of the management plane.

17. The system of claim 14, wherein the updating unit includes at least one among a network topology, link state information associated with a link, a total link bandwidth, a reserved bandwidth, a reservable bandwidth, a link color, and a TE Metric.
